(19) United States
(12) Patent Application Publication
(10) Pub. No.: US 2022/0088660 A1
(43) Pub. Date: Mar. 24, 2022

(54) Stainless-steel Tee-pipe Moulding Process

(71) Applicant: Zhejiang Delifu Technology Co., Ltd., Ningbo (CN)

(72) Inventor: Guofei WANG, Ningbo (CN)

(21) Appl. No.: 17/342,997

(22) Filed: Jun. 9, 2021

(30) Foreign Application Priority Data
Sep. 23, 2020 (CN) 202011008146.2

(51) Int. Cl. B21C 37/29

(52) U.S. Cl. CPC B21C 37/29

(57) ABSTRACT

The present invention discloses a stainless-steel tee-pipe moulding process, cutting out a main pipe and a secondary pipe from the stainless-steel pipe to replace the copper tee-pipe to resolve the problem that the copper tee-pipe is easy to corrode and causes water pollution; meanwhile, the moulding process of the stainless-steel tee-pipe of the invention is different from the traditional integral forming process, and saves more materials and reduces the production cost compared with the traditional integral forming process.

### CROSS-REFERENCE TO RELATED APPLICATIONS

This application claims priority to Chinese Patent Application No. 202011008146.2 with a filing date of Sep. 23, 2020. The content of the aforementioned application, including any intervening amendments thereto, are incorporated herein by reference.

### TECHNICAL FIELD

The present invention relates to the technical field of pipeline preparation and moulding, in particular to a stainless-steel tee-pipe moulding process.

### BACKGROUND

A multi-way pipe like a tee-pipe, as the most important accessory in pipeline construction, is mainly used at the key branch of a main pipeline. The widely used tee-pipe is generally moulded by carrying out hammer forging on a pipe blank and then carrying out die forging. However, such processing has the defects of large blanking weight, high cost, and the quality of the blank subjected to hammer forging and the forged surface is inferior. Besides, the existing copper tee-pipe is easy to corrode when used in connection with a water pipe, and easily causes water source pollution.

### SUMMARY

One objective of the present disclosure is to overcome the shortcomings of the prior arts by providing a stainless-steel tee-pipe moulding process to resolve the problems mentioned above, that is, the copper tee-pipe is easy to corrode and causes water source pollution, and the existing tee-pipe processing has the problem of large blanking weight and high cost.

The technical solution of the present disclosure is to provide a stainless-steel tee-pipe moulding process, comprising the following steps: S1, by taking a stainless-steel pipe as a processing raw material, cutting out a main pipe and a secondary pipe from the stainless-steel pipe; S2, flaring the bodies of the main and secondary pipes with a flaring apparatus; or necking two ports of the main pipe and one port of the secondary pipe with a necking apparatus; S3, carrying out thread treatment on the two ports of the main pipe and one port of the secondary pipe with a thread forming apparatus to form connecting threads; S4, forming a T-branch port on the body of the main pipe obtained after treatment in S3, meanwhile, cutting the other port of the secondary pipe to obtain a docking port matched with the T-branch port, and then welding the docking port of the secondary pipe with the T-branch port of the body of the main pipe to form a tee-pipe blank; and S5, carrying out surface electroplating on the tee-pipe blank obtained after treatment in S4 to form a tee-pipe end product.

As compared to the prior art, the stainless-steel tee-pipe moulding process provided in the present invention has the following beneficial effects that the stainless-steel tee-pipe replaces the existing copper one, such that when it is used to connect with a water pipe, harmful corrosion and pollution to drinkable water are reduced, and corrosion to the tee-pipe and pollution to a water source are avoided. In addition, the stainless-steel tee-pipe features high bearing water pressure and long service life. Further, the stainless-steel tee-pipe moulding process can replace the integrated forging moulding process, saving more materials and lowering production cost.

In a preferred embodiment, after flaring the bodies of the main and secondary pipes in S2, two ports of the main pipe and one port of the secondary pipe are necked using a necking apparatus.

In a preferred embodiment, the flaring treatment in S2 particularly comprises the following step of carrying out water swelling treatment on the main and secondary pipes via a water swelling die according to the pre-set swelling requirements. In this treatment process, the two ports of the main pipe keep unchanged under the effect of the water swelling die, while its body is subjected to bidirectional water swelling and moulding from the two ports of the main pipe by virtue of a water swelling apparatus, or one port of the main pipe is subjected to unidirectional water swelling and moulding. Similarly, the two ports of the secondary pipe keep unchanged under the effect of the water swelling die, while its body is subjected to bidirectional water swelling and moulding from the two ports of the secondary pipe by virtue of a water swelling apparatus, or one port of the secondary pipe is subjected to unidirectional water swelling and moulding.

In a preferred embodiment, the flaring treatment in S2 is carried out on the bodies of the main and secondary pipes respectively by an oil press and a pressure diffusing die for at least twice, the primary flaring ratio is 10%-15%, the secondary flaring ratio is 5%-8%, and multiple flaring treatment favourably avoids pipe body breakage caused by once flaring deformation.

The necking treatment in S2 is carried out on the two ports of the main pipe and one port of the secondary pipes respectively by an oil press and a necking die for at least twice, the primary necking ratio is 10%-15%, the secondary necking ratio is 5%-8%, and multiple necking treatment favourably avoids connecting port breakage caused by once necking deformation.

Preferably, the connecting threads formed in S3 are prepared into rolled threads via roll teeth.

Preferably, the connecting threads formed in S3 are prepared into sizing threads via a sizing mill and a sizing die.

### BRIEF DESCRIPTION OF THE DRAWINGS

FIG. 1 is a flow diagram of Embodiment 1 of the present invention.

FIG. 2 is a flow diagram of Embodiment 2 of the present invention.

### EMBODIMENTS

A clear and complete description about the technical solutions of the embodiments of the present invention will be given in conjunction with the appended drawings. Apparently, the described embodiments are merely a portion but not all, of the embodiments of the present invention. On the basis of the embodiments of the present invention, all other embodiments obtained by those of ordinary skill in the art without paying any creative effort, shall fall into the protection scope of the present invention.

### Embodiment One

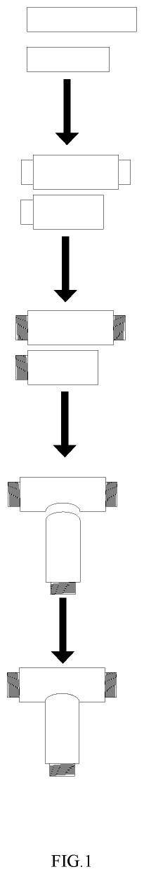

Referring to FIG. 1, the present invention provides a technical solution, i.e., a stainless-steel tee-pipe moulding process. In this embodiment, a stainless-steel pipe is used to prepare a 4.64 cm tee-pipe through the following specific steps:

S1, successively cutting out a 140 cm-long main pipe and a 60 cm-long secondary pipe from a stainless-steel pipe of which the calibre is 3.8 cm, with two ports of the main pipe and one port of the secondary pipe serving as connecting ports;

S2, carrying out water swelling treatment on the bodies of the main and secondary pipes via a swelling apparatus comprising a water swelling apparatus and an internal high-pressure apparatus. To be specific, water swelling dies corresponding to the main and secondary pipes in the primary swelling treatment are selected first, and then the main and secondary pipes are placed in the water swelling dies respectively. In the treatment process, the two ports of the main pipe keep unchanged under the effect of the water swelling die, while its body is subjected to bidirectional water swelling and moulding from the two ports of the main pipe by virtue of a swelling apparatus, or one port of the main pipe is subjected to unidirectional water swelling and moulding. Similarly, the two ports of the secondary pipe keep unchanged under the effect of the water swelling die, while its body is subjected to bidirectional water swelling and moulding from the two ports of the secondary pipe by virtue of a swelling apparatus, or one port of the secondary pipe is subjected to unidirectional water swelling and moulding.

Afterwards, water swelling dies corresponding to the main and secondary pipes in the secondary swelling treatment are selected, and then the above steps are repeated for carrying out secondary flaring treatment so as to obtain the main pipe with the internal pipe diameter being 4.64 cm and the secondary pipe with the internal pipe diameter of 4.19 cm, but the calibre of the two ports of the main pipe and one port of the secondary pipe is all kept at 3.8 cm.

S3, integrally rolling the outer walls of the connecting ports of the main and secondary pipes via a roll press to form rolled threads. Particularly, the 1.8 cm rolled threads are formed under the pressure of 200 KN-240 KN, with its thread pitch being 0.4 cm, thread height being 0.1 cm and nominal diameter being 4 cm.

S4, forming a 4.19 cm welding opening on the body of the main pipe after treatment in S3 through laser cutting, meantime laser cutting the other port of the secondary pipe to form a locking port matched with the welding opening, and splicing and laser welding the welding opening of the main pipe with the locking port of the secondary pipe via a laser welding torch to form a tee-pipe blank; and

S5, performing surface polishing and electroplating treatment on the tee-pipe blank obtained in S4 so as to obtain a tee-pipe end product.

### Embodiment Two

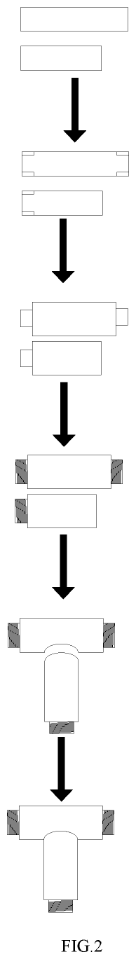

As shown in FIG. 2, this embodiment differs from Embodiment One in that: in S2 of this embodiment, an oil press is used as a necking apparatus to carry out necking treatment on the two ports of the main pipe and one port of the secondary pipe. To be specific, the oil press and a necking die are used to carry out necking treatment on the two ports of the main pipe and one port of the secondary pipe for at least twice, the primary necking ratio is 10%-15%, the secondary necking ratio is 5%-8%, and finally, the original calibre of the main pipe is reduced to 3.8 cm from 4.8 cm, and the original calibre of the secondary pipe is reduced to 3.5 cm from 4.3 cm; and a 4.8 cm welding opening is formed on the body of the main pipe in S4 so as to be laser welded with the secondary pipe.

### Embodiment Three

As shown in FIG. 3, on the basis of Embodiment One, after flaring treatment in S2, an oil press is used to carry out flaring treatment on the two ports of the main pipe and one port of the secondary pipe. To be specific, an oil press and a flaring die are used to carry out flaring treatment on the two ports of the main pipe and one port of the secondary pipe for at least twice, the primary flaring ratio is 10%-15%, the secondary flaring ratio is 5%-8%, and finally, the original calibre of the main pipe is expanded to 4.8 cm from 3.8 cm, and the original calibre of the secondary pipe is expanded to 4.3 cm from 3.5 cm. In addition, a sizing mill and a sizing die also can be used in S3 to form sizing threads.

Although the present invention has been explained in detail with reference to the above embodiments, it should be understood by those skilled in the art that, modifications to the technical solutions of the embodiments or even equivalent substitutions for partial technical features therein are allowed. Any modifications, equivalent substitutions or improvements that do not depart from the essence and scope of the present invention, shall be covered by the protection scope of the present invention.

1. A stainless-steel tee-pipe moulding process, wherein it comprises the following steps:
S1, by taking a stainless-steel pipe as a processing raw material, cutting out a main pipe and a secondary pipe from the stainless-steel pipe;
S2, flaring the bodies of the main and secondary pipes with a flaring apparatus; or necking two ports of the main pipe and one port of the secondary pipe with a necking apparatus;
S3, carrying out thread treatment on the two ports of the main pipe and one port of the secondary pipe with a thread forming apparatus to form connecting threads;
S4, forming a T-branch port on the body of the main pipe obtained after treatment in S3, meanwhile, cutting the other port of the secondary pipe to obtain a docking port matched with the T-branch port, and then welding the docking port of the secondary pipe with the T-branch port of the body of the main pipe to form a tee-pipe blank; and
S5, carrying out surface electroplating on the tee-pipe blank obtained after treatment in S4 to form a tee-pipe end product.

2. The stainless-steel tee-pipe moulding process of claim 1, wherein after flaring the bodies of the main and secondary pipes in S2, two ports of the main pipe and one port of the secondary pipe are necked using a necking apparatus.

3. The stainless-steel tee-pipe moulding process of claim 1, wherein the flaring treatment in S2 comprises the following step of carrying out water swelling treatment on the main and secondary pipes via a water swelling die according to the pre-set swelling requirements; during the process, the two ports of the main pipe keep unchanged under the effect of the water swelling die, while its body is subjected to bidirectional water swelling and moulding from the two ports of the main pipe by virtue of a water swelling apparatus, or one port of the main pipe is subjected to unidirectional water swelling and moulding; the two ports of the secondary pipe keep unchanged under the effect of the water swelling die, while its body is subjected to bidirectional water swelling and moulding from the two ports of the secondary pipe by virtue of a water swelling apparatus, or one port of the secondary pipe is subjected to unidirectional water swelling and moulding.

4. The stainless-steel tee-pipe moulding process of claim 1, wherein the flaring treatment in S2 is carried out on the bodies of the main and secondary pipes respectively by an oil press and a pressure diffusing die for at least twice, the primary flaring ratio is 10%-15%, the secondary flaring ratio is 5%-8%; the necking treatment in S2 is carried out on the two ports of the main pipe and one port of the secondary pipes respectively by an oil press and a necking die for at least twice, the primary necking ratio is 10%-15%, the secondary necking ratio is 5%-8%.

5. The stainless-steel tee-pipe moulding process of claim 1, wherein the connecting threads formed in S3 are prepared into rolled threads via roll teeth.

6. The stainless-steel tee-pipe moulding process of claim 1, the connecting threads formed in S3 are prepared into sizing threads via a sizing mill and a sizing die.

7. The stainless-steel tee-pipe moulding process of claim 2, wherein the flaring treatment in S2 is carried out on the bodies of the main and secondary pipes respectively by an oil press and a pressure diffusing die for at least twice, the primary flaring ratio is 10%-15%, the secondary flaring ratio is 5%-8%; the necking treatment in S2 is carried out on the two ports of the main pipe and one port of the secondary pipes respectively by an oil press and a necking die for at least twice, the primary necking ratio is 10%-15%, the secondary necking ratio is 5%-8%.
